(19) United States
(12) Patent Application Publication
(10) Pub. No.: US 2018/0037170 A1
(43) Pub. Date: Feb. 8, 2018

(54) DEVICE FOR SECURING PLURALITY OF LOADS OVER A ROOF RACK OF THE VEHICLE

(71) Applicant: Mr. Nicholas Millington, Auckland (NZ)

(72) Inventor: Nicholas Millington, Auckland (NZ)

(73) Assignee: Mr. Nicholas Millington, Auckland (NZ)

(21) Appl. No.: 15/230,510

(22) Filed: Aug. 8, 2016

(51) Int. Cl. B60R 9/045; B60R 9/10; B60R 9/12; B60R 9/048

(52) U.S. Cl. CPC B60R 9/045; B60R 9/048; B60R 9/10; B60R 9/12

(57) ABSTRACT

Disclosed is a device for securing plurality of loads over a roof rack of the vehicle. The device includes plurality of elongated bars integrated with the roof rack, and one or more hooking unit. The hooking unit including plurality of grub screws to slip into the plurality of bars to maintain the aerodynamic integrity of the roof rack bars. In one embodiment the hooking unit is movable into at least one of an upright position and a down position. The upright position of the hooking unit enables the hooking unit to sec re loads on the roof rack. The down position of the hooking unit visually disappear the roof rack and maintains the aerodynamic aspects of the plurality of elongated bars.

### TECHNICAL FIELD

The presently disclosed embodiments are related, in general, to load carrying devices. More particularly, the presently disclosed embodiments are related to a device for securing plurality of loads over a roof rack of the vehicle.

### BACKGROUND

Various types of vehicle roof racks have been developed to facilitate transportation of loads, bicycle, and skis. These roof racks are typically secured to the roof on a vehicle and provide attachment points for the various items of sporting gear. The fundamental components of such racks are a pair of spaced-apart parallel crossbars supported above the roof of the vehicle by towers disposed at each end of each crossbar. The crossbars provide a standard base to which various accessories are attached to accommodate different loads. These roof racks creates aerodynamic drag and noise. People use their roof racks rarely, they are faced with the problem of what to do with roof racks when not in use.

Thus, there is a necessity for a device to allow verities of loads to be carried on roof racks and creates easy to use tie down arrangement for a range of typical loads secured on the roof racks.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there may be provided a device a device for securing plurality of loads over a roof rack of the vehicle. The device includes plurality of elongated bars integrated with the roof rack, and one or more hooking unit. The hooking unit including plurality of grub screws to slip into the plurality of bars to maintain the aerodynamic integrity of the roof rack bars. In one embodiment the hooking unit is movable into at least one of an upright position and a down position. The upright position of the hooking unit enables the hooking unit to secure loads on the roof rack. The down position of the hooking unit visually disappears the roof rack and maintains the aerodynamic aspects of the plurality of elongated bars.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a first exemplary view of the device,in accordance with at least one embodiment;

FIG. 2 is a second exemplary view of the device, in accordance with at least one embodiment; and

FIG. 3 is an exemplary view of the hooking unit, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods and systems may extend beyond the described embodiments. For example, the teachings presented and the needs of a particular application may yield multiple alternative and suitable approaches to implement the functionality of any detail described herein. Therefore any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

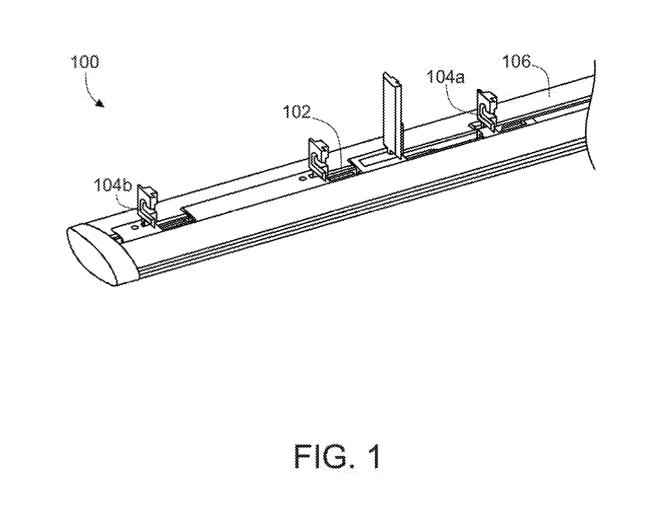

FIG. 1 is a first exemplary view of the device 100, in accordance with at least one embodiment. As shown in FIG. 1, by ay of example but not limitation, exemplary view of the device 100. The device 100 for securing plurality of loads over a roof rack of the vehicle.

For certain example embodiments, a roof racks may be pre-assembled. The aforementioned roof racks are safe and provides secure load carrying. These roof racks includes aerodynamic load bars and additionally has possibility to add carriers for bikes, kayaks, and boards, a combination thereof, or so forth. However, claimed subject matter is not limited to any particular described embodiments, implementations, examples, etc.

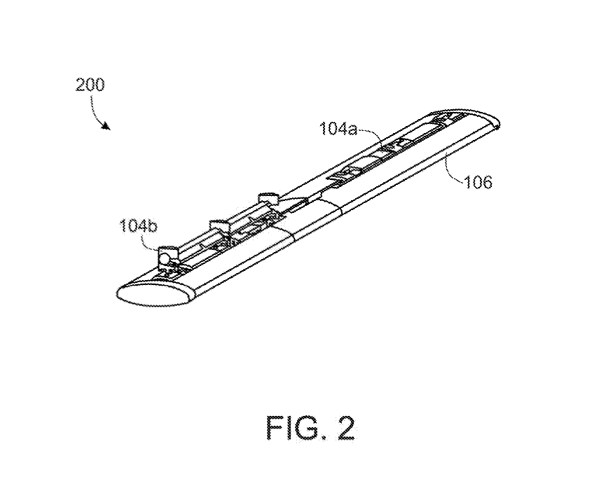

As shown in FIG. 1 the device 100 includes plurality of elongated bars 102 integrated with the roof rack 106, and one or more hooking unit 104a and 104b. The hooking unit 104 including plurality of grub screws to slip into the plurality of bars to maintain the aerodynamic integrity of the elongated bars 102. In one embodiment the hooking unit 104 is movable into at least one of an upright position and a down position. The upright position, of the hooking unit 104 enables the hooking unit to secure loads on the roof rack 106. The down position of the hooking unit 104 visually disappears the roof rack 106 and maintains the aerodynamic aspects of the plurality of elongated bars 102. The hooking unit 104 includes a groove to receive the plurality of elongated bars 102. FIG. 2 is a second exemplary view of the device, in accordance with at least one embodiment.

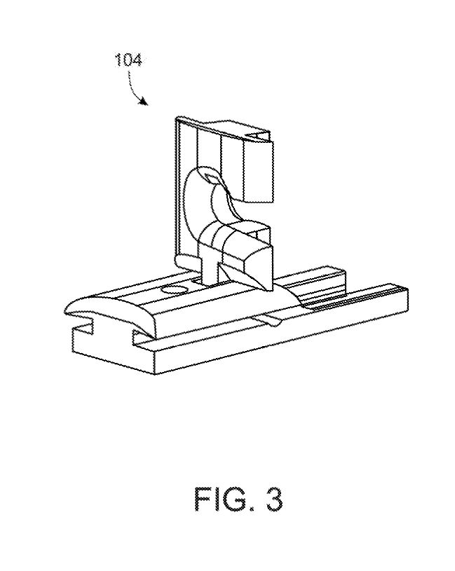

FIG. 3 is an exemplary view of the hooking unit 104, in accordance with at least one embodiment. The present hooking unit 104 is designed in such a way that the hooking unit 104 slips into aerodynamic roof rack bars maintaining the aerodynamic integrity of the roof rack bars. The hinged hooking unit 104 a lows a range of loads to be carried on roof racks and creates a very easy to use tie down system for a range of typical loads that might be secured on roof racks. When in the down position the aero dynamic characteristics of the roof rack bars remains in tack. The aforementioned arrangement is necessary to save fuel and further provides the generic look of the roof rack bars and the wind noise created when traveling at speeds.

A person skilled in the art will understand that the roof racks described herein for illustrative purposes and should not be construed to limit the scope of the disclosure. Various embodiments of the disclosure encompass numerous advantages including apparatuses, methods and systems for reducing force per unit area applied on an arm from the plurality of arms in event of collision.

A person with ordinary skills in the art will appreciate that the apparatuses, systems, and devices have been illustrated and explained to serve as examples and should not be considered limiting in any manner. It will be further appreciated that the variants of the above disclosed system elements, modules, and other features and functions, or alternatives thereof, may be combined to create other different apparatuses, systems or applications.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed but that the present disclosure will include all embodiments falling within the scope of the appended claims.

What is claimed is:

1. A device for securing plurality of loads over a roof rack of the vehicle, the device comprising: plurality of elongated bars integrated with the roof rack; and one or more hooking unit including plurality of grub screws to slip into the plurality of bars to maintain the aerodynamic integrity of the elongated bars, wherein the hooking unit is movable into at last one of: an upright position and a down position.

2. The upright position of the hooking unit according to claim 1 enables the hooking unit to secure loads on the roof rack.

3. The down position of the hooking unit according to claim 1 visually disappears the roof rack and maintains the aerodynamic aspects of the plurality of elongated bars.

4. The hooking unit according to claim 1 includes a groove to receive the plurality of bars.
